(19) United States
(12) Patent Application Publication
(10) Pub. No.: US 2009/0086874 A1
(43) Pub. Date: Apr. 2, 2009

(54) Apparatus and method of elastic buffer control

(76) Inventors: Junning Wang, Shanghai (CN); Song Gao, Shanghai (CN); Shubing Zhai, Shanghai (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/906,002

(22) Filed: Sep. 28, 2007

(51) Int. Cl. H04L 7/00

(52) U.S. Cl. 375/372

(57) ABSTRACT

A method, system, and apparatus for synchronizing an asynchronous data transmission between a transmitter and a receiver are presented. For example, an elastic buffer can include a symbol storage coupled to receive transition data from a transmitter and to store the transition data in a plurality of addressable symbol storage elements; a write clock domain, which operates at a recovery clock, for selecting a symbol storage element of symbol storage to store the transition data, determining whether a SKIP ordered set has occurred, and deleting a SKIP symbol of the SKIP ordered set based on the determination to prevent the deleted SKIP symbol from being stored in symbol storage; and a read clock domain, which operates at a local clock, for selecting a symbol storage element of the symbol storage to retrieve the transition data as receiver data, determining whether a SKIP ordered set is occurring, adding a SKIP symbol to the receiver data based on the determination; and providing the receiver data to a receiver.

### FIELD

The embodiments of the present invention generally relate to an elastic buffer in high-speed digital communication, and in particular, to an implementation method of the elastic buffer provided to transition data from one clock domain to another clock domain in a Peripheral Component Interconnect Express (PCI-E) system device.

### BACKGROUND

A PCI-E device (also known as a third generation high performance I/O bus) has the ability to convert a received bit stream into a recovery clock signal and a transition data signal. The transition data signal is derived by converting the received bit stream into parallel data by using a serial-to-parallel converter. The recovery clock signal is derived from the bit transitions of the received bit streams by using a Clock Data Recovery circuit (CDR). When using a CDR for high-speed data communication, data corruption can occur due to clock signal and data signal skewing. For example, an offset and/or fluctuation of the operational clock frequencies on the transmission side and the reception side may shift a clock in a given time direction.

It is a common design practice for a PCI-E device to use a locally generated clock to clock most of the receive path logic. To compensate for the frequency difference between the recovery clock signal and the locally generated signal and to provide an improved asynchronous data transmission synchronization method between the recovery clock and the local clock, an elastic buffer is incorporated within a receive data path.

To synchronize the two clocks according to the PCI-E link specification portion, the transmitter on the remote end periodically transmits a special symbol sequence called the SKIP Ordered-Set. The elastic buffer compensates for the difference between the two clocks by either deleting one SKIP symbol from or inserting one SKIP symbol into each of the SKIP sequences contained in the elastic buffer. Specifically, the current version (Ver2.0) of PCI-E system supports two signaling rate configurations: Gen1 and Gen2. For elastic buffer implementations that support the Gen2 signaling rate configuration, there can be two symbols of data input for every clock cycle.

One challenge for implementing the elastic buffer is to ensure the integrity of high-speed data communications between two different clock domains. As defined by the PCI-E link specification, the elastic buffer needs to store two symbols for each entry at every clock cycle when the link is trained to a higher data transmission rate (Gen2, PCI-E). There are, however, a number of problems associated with implementing the elastic buffer. One major problem occurs when handling only one SKIP symbol, which is used for compensating a frequency difference between the two ends of the elastic buffer and for ensuring that the elastic buffer reads the data out in the same order that it was written into the buffer while receiving a SKIP Ordered-Set sequence. Data corruption and/or a substantial loss of data can occur when the elastic buffer fails to maintain the order of received data streams when handling SKIP symbol. Further, a failure to handle even one SKIP symbol may result in further miscommunication between the writing and receiving ends of the elastic buffer. Another problem relates to properly controlling the elastic buffer to avoid data overflow/underflow while still matching the PCI-E system's specific application.

One method commonly employed to establish data bus synchronization between asynchronous clock domains is the use of one or more data hold registers and a handshaking mechanism. First, a write circuit periodically samples a transition data value into multiple hold registers, and asserts a synchronized ready signal to the read clock domain. The read clock domain recognizes the ready signal and sends back a synchronized acknowledge signal to the write clock domain. The sampled data must not change until the acknowledge signal is received by the write clock domain. Upon receiving the acknowledge signal, the write clock domain has permission to clear the ready signal and re-sample the transition data value.

However, two symbols are available for every clock cycle in a PCI-E application, including the time for waiting for an acknowledge signal. There are at least three clock cycles of delay from sending a ready signal to receiving its acknowledge signal. That is to say, the sampled hold register should have the capacity to store the transition data value for at least three clock cycles before they are sampled to receive clock domain. This also adds three clock cycles of latency to the elastic buffer. In addition, the method will typically add more pessimism to the assertion of overflow and underflow of the elastic buffer and might require additional space to compensate for the added pessimism. The above technique will not likely work in applications where a lower latency and smaller buffer size of the elastic buffer is required, such as PCI-E devices provided on integrated circuits.

In the circuit disclosed in U.S. Pat. No. 6,594,329, an elastic buffer enables link data received from a link to be synchronized into a receiver clock domain of data receiver. However, in most application cases, clock frequencies used between the transmission side and the reception side are sufficiently close to each other and, more especially, both sides can have the same clock frequency. In this circuit, the elastic buffer prevents all IDLE symbols, included in the link data, from being stored in the buffer so as to prohibit data overflow, and later inserts many NOP (No-Operation) symbols into receiver data so as to prohibit data underflow. Accordingly, this implementation method of the elastic buffer is not flexible and intelligent. Further, this implementation method cannot determine whether to delete the current IDLE symbol or whether to add the current NOP symbol. When a common clock occurs at the two ends of a link, the elastic buffer will frequently alter the integrity of the data packets being transferred between the write data domain and the read data domain. For example, the elastic buffer will delete all IDLE symbols, while later inserting into data packets the same number of NOP symbols.

### SUMMARY

In accordance with some embodiments of the present invention, a method, system, and apparatus for synchronizing an asynchronous data transmission between a transmitter and a receiver are presented. An elastic buffer, according to some embodiments, can synchronize an asynchronous data transmission between a transmitter and a receiver by compensating a clock difference between a write clock from the transmitter and the read clock from a receiver. The elastic buffer can include a write processor, a symbol storage, and a read processor. The write processor receives write data, which represents at least a first write symbol and a second write symbol, from the transmitter based on a write clock signal wherein the write processor further includes: a first write register that stores the first write symbol; a second write register that stores the second write symbol; a write comparator that determines whether the first write symbol and the second write symbol correspond to a SKIP ordered set, which may include at least one of first write symbol and second write symbol being a SKIP symbol; and a write hold register that has the capability to store a symbol of write data based on the determination by the write comparator, wherein, according to the determination, the write processor discards the SKIP symbol of one of first write symbol or second write symbol, provides the non-discarded symbol of first write symbol or second write symbol to the write hold register, receives a subsequent set of write data including at least a third write symbol. The symbol storage is configured to store the non-discarded symbol located in write hold register and the third write symbol according to the write clock. The read processor is configured to receive read data, which represents at least a first read symbol and a second read symbol, from the symbol storage based on a read clock signal from the receiver, wherein the read processor further includes: a first read register that stores the first read symbol; a second read register that stores the second read symbol; a read comparator that determines whether the first read symbol and the second read symbol correspond to a SKIP ordered set, which may include at least one of first read symbol and second read symbol being a SKIP symbol; and a read hold register that has the capability to store a symbol of read data based on the determination by the read comparator, wherein, according to the determination, the read processor adds a SKIP symbol to the read hold register, provides the first read symbol and the second read symbol to the receiver, passes the SKIP symbol from read hold register to the first read register, receives a subsequent set of read data including at least a third read symbol, and provides the SKIP symbol from first read register and the third read symbol to the receiver.

According to some embodiments of the invention, an elastic buffer can include a symbol storage coupled to receive transition data from a transmitter and to store the transition data in a plurality of addressable symbol storage elements; a write clock domain, which operates at a recovery clock, for selecting a symbol storage element of symbol storage to store the transition data, determining whether a SKIP ordered set has occurred, and deleting a SKIP symbol of the SKIP ordered set based on the determination to prevent the deleted SKIP symbol from being stored in symbol storage; and a read clock domain, which operates at a local clock, for selecting a symbol storage element of the symbol storage to retrieve the transition data as receiver data, determining whether a SKIP ordered set is occurring, adding a SKIP symbol to the receiver data based on the determination; and providing the receiver data to a receiver.

According to some embodiments, a system can include a clock data recovery that receives an incoming bit stream and provides a recovery clock; a converter that receives the incoming bit stream and provides transition data; a receiver for receiving receiver data, wherein the receiver operates on a local clock; and an elastic buffer. The elastic buffer can further include a symbol storage coupled to receive transition data from the converter according to the recovery clock and to store the transition data in a plurality of addressable symbol storage elements; a write clock domain, which operates at the recovery clock, for selecting a symbol storage element of symbol storage to store the transition data, determining whether a SKIP ordered set has occurred, and deleting a SKIP symbol of the SKIP ordered set based on the determination to prevent the deleted SKIP symbol from being stored in symbol storage; and a read clock domain, which operates at the local clock, for selecting a symbol storage element of the symbol storage to retrieve the transition data as receiver data, determining whether a SKIP ordered set is occurring, adding a SKIP symbol to the receiver data based on the determination; and providing the receiver data to the receiver.

According to some embodiments of the invention, a method can include receiving a first set of write data, which includes a first symbol and a second symbol, according to a write clock; determining whether the received write data includes a first SKIP ordered set; discarding one of the first symbol or second symbol based on the determination wherein at least one first symbol and second symbol is a SKIP symbol; receiving a second set of write data, which includes at least a third symbol; and storing the non-discarded symbol and the third symbol in a symbol storage, which can provide the non-discarded symbol and the third symbol to a read clock portion of an elastic buffer for providing to a receiver according to a receiver clock cycle.

According to some embodiments of the invention, a method can include receiving a first set of read data from a symbol storage based on a clock cycle from a receiver, wherein the first set of read data includes a first symbol and a second symbol; determining whether the received read data includes a first SKIP ordered set; adding a SKIP symbol based on the determination; transmitting the first set of read data to the receiver; receiving a second set of read data from the symbol storage, wherein the second set of read data includes a third symbol and a fourth symbol; and transmitting the SKIP symbol and the third symbol to the receiver.

### BRIEF DESCRIPTION OF THE DRAWINGS

FIG. 1 illustrates a block diagram of an exemplary system including an elastic buffer providing a synchronization technique for asynchronous data in high-speed data communications.

FIG. 2 illustrates an exemplary timing chart when transmitting a SKIP order-set over the elastic buffer of a PCI-E link, which is trained at a PCI-E Gen2 signaling rate, and further illustrates data sequences at a local clock side where the elastic buffer deletes a SKIP symbol from the SKIP ordered-set.

FIG. 3 illustrates a functional block diagram of an exemplary elastic buffer architecture according to some embodiments of the invention.

FIG. 4 illustrates an exemplary circuit diagram of a write processor in the write clock domain part of FIG. 3 according to some embodiments of the invention.

FIG. 5 illustrates an exemplary circuit diagram of a read processor in the read clock domain part of FIG. 3 according to some embodiments of the invention.

FIG. 6 illustrates a circuit diagram of an exemplary pointer generation unit used in the elastic buffer.

FIG. 7 represents an exemplary method for determining whether a SKIP ordered set has occurred at a write clock domain of an elastic buffer.

FIG. 8 represents an exemplary method for determining whether a SKIP ordered set has occurred at a read clock domain of an elastic buffer.

### DETAILED DESCRIPTION OF THE EMBODIMENTS

Reference will now be made in detail to the exemplary embodiments implemented according to the invention, the examples of which are illustrated in the accompanying drawings. Wherever possible, the same reference numbers will be used throughout the drawings to refer to the same or like parts.

The present invention is applicable for all computer network components using a CDR circuit in high-speed data communications. The following description describes embodiments providing an improved elastic buffer that implements a synchronization technique for asynchronous link data. This technique can be implemented using integrated circuit techniques and may be particularly useful in a system using a signal rate having two symbols of entry for every clock cycle.

Some embodiments further provide flexible control for adding or removing only one “don't care” symbol (e.g., SKIP symbol) from the elastic buffer where there are two entry symbols for every clock cycle. These improved embodiments provide a more robust elastic buffer that provides better flexibility in determining whether to add/remove the redundant “don't care” characters.

Additionally, some embodiments provide an improved apparatus and method for efficient asynchronous elastic buffer control. The elastic buffer has a better timing slack, a smaller area, and a lower latency than the typical asynchronous handshake implementation.

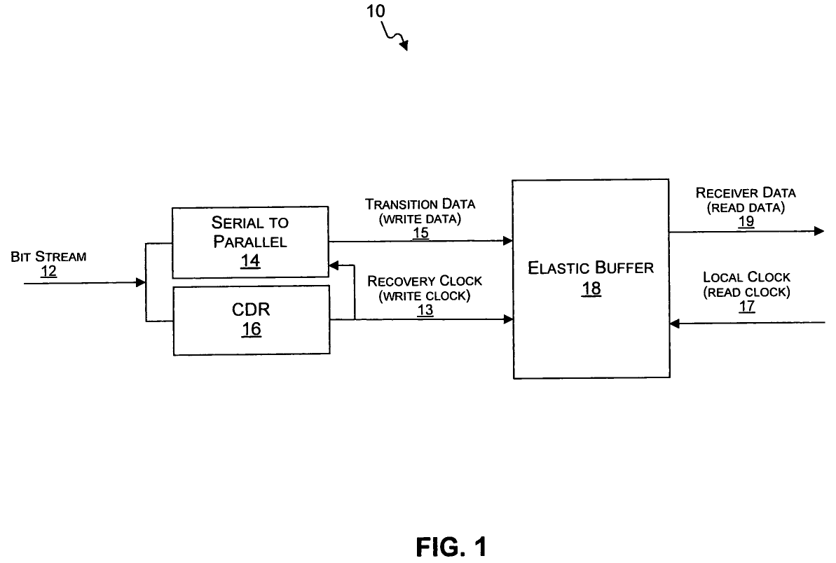

FIG. 1 illustrates a block diagram of an exemplary system including an elastic buffer providing a synchronization technique for asynchronous link data in high-speed data communications. The system 10 includes, among other things, a serial-to-parallel converter 14, a Clock Data recovery circuit (CDR) 16, and an elastic buffer 18.

As illustrated, a serial bit stream 12 is applied to the terminals of CDR 16 and serial-to-parallel converter 14. After receiving the serial bit stream 12 clocked out of a remote transmitter device, CDR 16 generates a recovery clock signal (write clock) 13 to provide to both serial-to-parallel converter 14 and elastic buffer 18. Recovery clock signal 13 is frequency-divided into units of parallel data. CDR 16 can transfer only a data sequence in series without transmitting a clock signal and can reproduce a clock signal from the received bit stream 12 based on the bit transitions of the received bit streams. The transitions between the incoming serial bit stream 12 are used to re-synchronize and maintain bit lock in CDR 16 while generating a recovery clock signal 13 from the serial bit stream 12. The recovery clock signal 13 can clock serial-to-parallel converter 14, which outputs the multi-bit transition data 15 to elastic buffer 18.

When the frequencies of the clock signal used on the transmission side and the reception side are sufficiently close to each other, it is possible to connect the transmitting and receiving circuits by elastic buffer 18. Elastic buffer 18 can elastically compensate for any difference between the transmitter data rate and the receiver data rate.

The multi-bit transition data 15 are clocked into the elastic buffer 18 using the recovery clock signal 13 generated by CDR 16. Elastic buffer 18 is used for clock tolerance compensation; i.e., for adjusting minor clock frequency variation between write clock 13 used to clock the incoming bit stream into elastic buffer 18 and the locally generated clock (read clock) 17 used to clock data out of elastic buffer 18. Elastic buffer 18 can synchronize the asynchronous data transmission from the recovery clock domain (write clock domain) to the locally generated clock domain (read clock domain).

Elastic buffer 18 uses the CDR-generated recovery clock signal as the write clock signal 13 and the locally generated clock signal as the read clock signal 17. Jitter can disturb the phase relationship between write clock signal 13 and read clock signal 17. Further, the phase difference between the two may increase in a leading or lagging direction under the influence of the frequency offset.

According to the linking portion of the PCI-Express system specification, the transmitter on the remote end periodically transmits a special symbol sequence called the SKIP ordered-set. The SKIP ordered-set includes at least four control symbols (a COM character followed by three SKIP characters; the SKIP is the “don't care” character, hence the name “SKIP”). In some instances, elastic buffer 18 may need to add or remove one SKIP symbol from the received symbol stream to compensate for the transmitter-to-receiver clock frequency deviations.

Specifically, current version (Ver2.0) of PCI-E system supports two signaling rate configurations: Gen1 and Gen2. For elastic buffer implementations that support the Gen2 signaling rate, there may be two data input symbols for every clock cycle. That is to say, two symbols for each entry are needed due to the Gen2 signaling rate configuration.

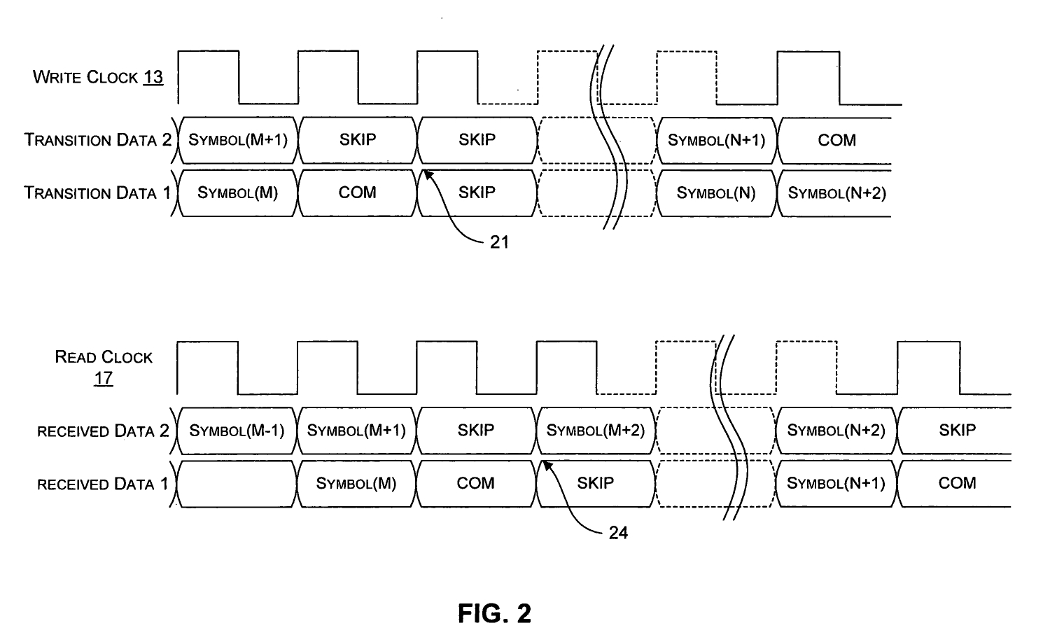

For example, FIG. 2 illustrates an exemplary timing chart when transmitting a SKIP order-set over the elastic buffer of a PCI-E link, which is trained at a PCI-E Gen2 signaling rate. A SKIP ordered-set 21 (a COM character of Transition Data 1 in second column followed by three SKIP characters, which includes the SKIP character of Transition Data 2 in second column and the two SKIP characters in third column of transition data) is moving across the parallel interface at write clock 13. At local clock 17, elastic buffer 18 can remove one SKIP symbol 24 from the SKIP ordered-set to appropriately manage its symbol storage level, resulting in a SKIP sequence 24 that only has two SKIP symbols being transferred across the parallel interface.

This elastic buffer 18 refers to an asynchronous FIFO (first in, first out) design where data values are written to elastic buffer 18 in the write clock domain and the data values are read out from the same buffer in the read clock domain, and the two clock domains are asynchronous to each other. In some embodiments, elastic buffer 18 has a circular buffer with a plurality of symbol storage registers. Several special units are considered and added to elastically handle the SKIP symbol of inbound or outbound packets to match the network application on the basis of general FIFO architecture.

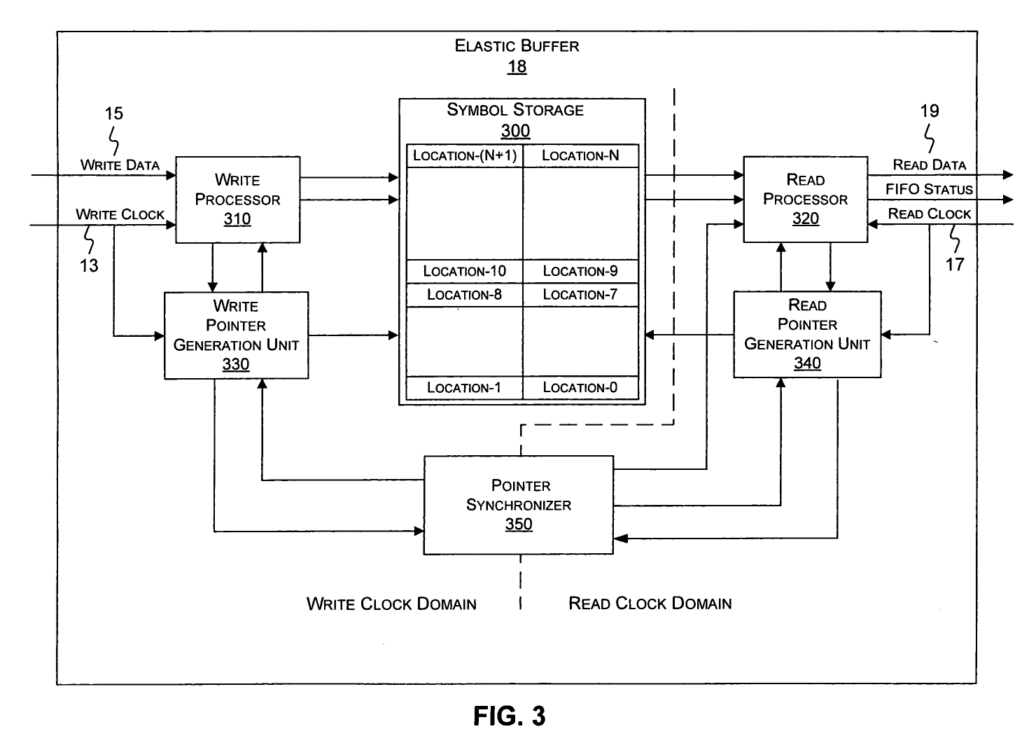

FIG. 3 illustrates a functional block diagram of an exemplary elastic buffer architecture according to some embodiments of the invention. Elastic buffer 18 may include, among other things, a symbol storage 300, a write processor 310, a read processor 320, a write pointer generation unit 330, a read pointer generation unit 340, and a pointer synchronizer 350. In some embodiments, pointer synchronizer 350 can have multiple synchronizers, such as a write pointer synchronizer and read pointer synchronizer.

Elastic buffer 18 can store successive symbols in the symbols storage elements (location-0 to location-(N+1)) of symbol storage 300. Symbol storage 300 stores these incoming symbols in successive order so that elastic buffer 18 can read these symbols in the order that they were received. By doing so, transferred data can remain more corrupt free. When a link is trained at a PCI-E Gen2 signaling rate configuration, there are two entry symbols that can be stored into or read out from an elastic buffer for every clock cycle. For example, for every read clock cycle, a read pointer may need to be incremented twice for appropriately reading the two corresponding symbols out of the two storage elements of symbol storage 300. When the above condition occurs, it can be difficult for a typical elastic buffer to code a read pointer in the form of a state machine when the states are encoded with Gray code, a binary code where only one bit is changed between two adjacent codes.

To overcome this, according to some embodiments of the invention, symbol storage 300 can arrange two basic storage elements at each address location of buffer. An adjacent pair is defined as two logically close elements. This allows two adjacent symbol storage elements to be written into or read from during a single clock cycle. For example, these adjacent symbol storage elements could be locations 7 and 8, locations 8 and 9, or locations 9 and 10 listed above. This approach also allows the use of Gray code to eliminate the problem associated with trying to synchronize multiple changing pointer signals. Symbol storage 300 may be implemented using simply successive banks of D-type flip-flops to provide the necessary elasticity required for proper data handling.

Referring to FIG. 3, elastic buffer 18 receives write data 15 and write clock 13. Write processor 310 of elastic buffer 18 receives write data 15 and write clock 13, while write pointer generation unit 330 of elastic buffer 18 receives write clock 13. Write processor 310 adds data into symbol storage 300 as fast as two symbols per write clock cycle.

Accordingly, elastic buffer 18 receives read clock 17 and provides read data 19 and FIFO status to a receiver. Read processor 320 of elastic buffer 18 accesses symbol storage 300, at a rate of two symbols per clock cycle, for the read data and provides the appropriate data according to the received read clock 17. Read pointer generation unit 340 also receives read clock 17 and can update the read pointer position upon determining that read processor 320 has accessed symbols from symbol storage 300.

Removing one SKIP operation is implemented in the write processor 310 and adding one SKIP operation is implemented in the read processor 320. Two pointers (write and read) control the write and read operations. The write pointer generation unit 330 generates a binary code to point to the next location to be written to in symbol storage 300 and generates a Gray code, which is provided to pointer synchronizer 350 for synchronizing the binary code with the read clock domain. Similarly, read pointer generation unit 340 generates a binary code to point to the current location of symbol storage 300 to be read from and generates a Gray code, which is provided to pointer synchronizer 350 for synchronizing the binary code with the write clock domain. Each of the two pointers increments by one at its respective active clock edge and get synchronized at the active edge of the opposite clock domain by the pointer synchronizer 350.

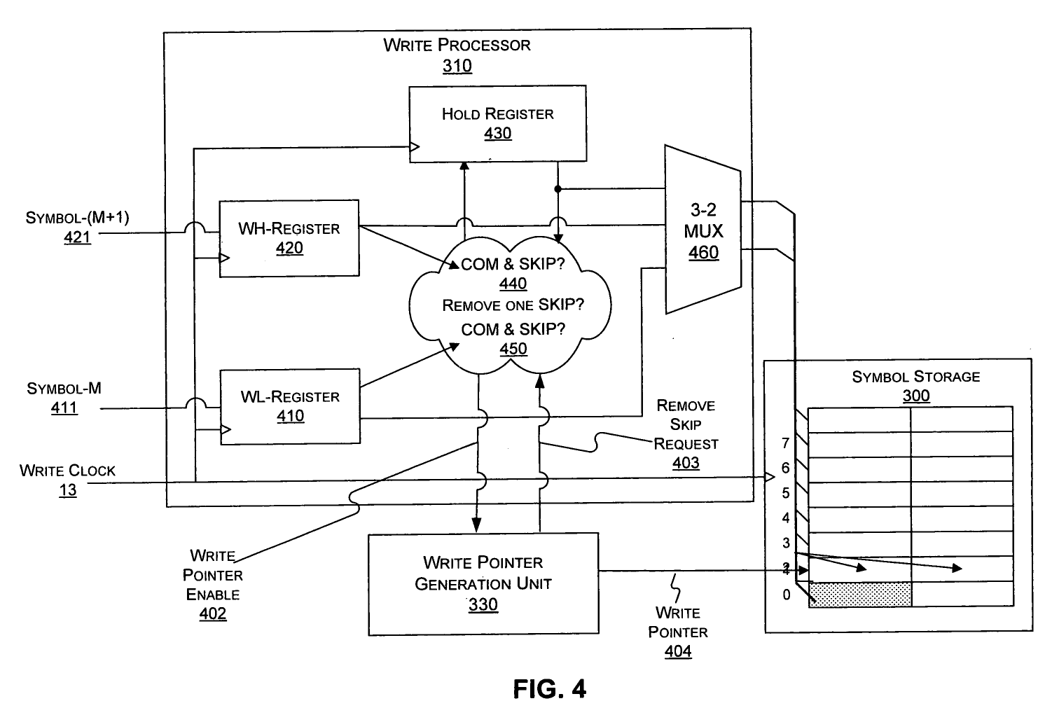

FIG. 4 illustrates an exemplary block diagram of write processor 310 in the write clock domain part of FIG. 3 according to some embodiments of the invention. Write processor 310 may comprise, among other things, two input data registers 410 and 420, a hold register 430, two equality comparators 440 and 450, and a three-to-two mux selector 460.

According to the PCI-E Gen2 signaling rate configuration, a write cycle is defined as each write clock cycle. Write processor 310 receives two symbols from the link in one write cycle and writes them into adjacent elements of symbol storage 300. Write processor 310 examines data received from the link and determines which SKIP symbol is relevant and requires further processing. In particular, write processor 310 functions to identify PCI-E specific SKIP sequences, as a received sequence of a comma control character (COM) followed by three defined SKIP data characters. One SKIP symbol from each SKIP ordered-set may be prohibited from entering the symbol storage 300 so as to allow write clock 13 to be faster than read clock 17 without causing the undesirable data overflow of symbol storage 300.

Data registers 410, 420 receive their respective symbol 411, 421, clocked with write clock 13. In this exemplary embodiment, WL-register 410 receives symbol-M 411 and provides symbol-wl. WH-register receives symbol-(M+1) 421 and provides symbol-wh. In this exemplary embodiment, symbol-wl precedes symbol-wh because symbol-wl corresponds to the earlier (symbol-M 411) of two incoming symbols 411, 412.

Upon receiving symbol-wl and symbol-wh from their respective registers 410, 420, equality comparator 440 determines whether the sequence latched in WL-register 410 and WH-register 420 is a SKIP ordered-set. Equality comparator 440 confirms whether a SKIP ordered-set has occurred by examining if two successive symbols are COM and SKIP symbols. If a SKIP ordered-set does not occur, the two symbols can be written into two adjacent elements of symbol storage 300 at the active edge of write clock 13. For example, symbol-wl (symbol-M) can be stored in the first symbol element, while symbol-wh (symbol-M+1) can be stored in the second symbol element. Further, write processor 310 sets write pointer enable signal 402 to a high level for enabling write pointer generation unit 330 to increment write pointer 404 appropriately at symbol storage 300.

If a SKIP ordered-set does occur, write processor 310 communicates to write pointer generation unit 330 by indicating that one has occurred through write pointer enable symbol 402. Write pointer generation unit 330 asserts a remove SKIP request signal 403 to write processor 310, which begins to monitor the incoming data stream. When the remove SKIP request signal 403 has been asserted and a SKIP ordered-set is detected (the equality comparator 440 is true and symbol-wh is a SKIP character), write processor 310 can discard the SKIP symbol latched in WH-register 420 and de-assert the write pointer enable signal 402 for one write clock cycle to stop the write operation and the write pointer increment from incrementing so that the SKIP signal is not stored in symbol storage 300.

The residual single symbol latched in WL-register 410 can be written into hold register 430, which provides symbol-whold. At the next write operation, the symbol-whold from hold register 430 and the new symbol-wl from WL-register 410 can be assembled together and then written into symbol storage 300 while the new symbol latched in WH-register 420 is copied to hold register 430. Beginning from this time, the WH-register 420 acts as a previous hold register by holding a signal, hold register 430 acts as WL-register by providing the earlier signal 410, and WL-register 410 acts as WH-register 420 by providing the latter signal. This special assemble process occurs until the next SKIP symbol is removed. Then, the original functions of WL-register 410, WH-register 420, and hold register 430 resume when the number of removed SKIP symbols runs up to an even number.

Write processor 310 provides a 3-2 mux selector 460 for selecting two symbols to assemble from three registers 410, 420, and 430. Write processor 310 can provide two equality comparators 440 and 450 because there are three symbols latched in respective registers only two symbols written into symbol storage 300 for one write cycle. For example, the combination of COM and SKIP may appear in symbol-wl from WL-register 410 and symbol-wh from WH-register 420, or symbol_whold from hold register 430 and symbol-wl from WL-register 410. Based on the comparing, one or more of equality comparators 440, 450 provide a signal to 3-2 mux 460 selector, which provides the designated symbols for storing in an adjacent element of symbol storage 300.

Accordingly, the write processor 310 can remove one SKIP character to appropriately manage the buffer and ensure that residual characters maintain their original order. The PCI-E Gen2 signaling rate is matched via a flexible control operation on write hold register.

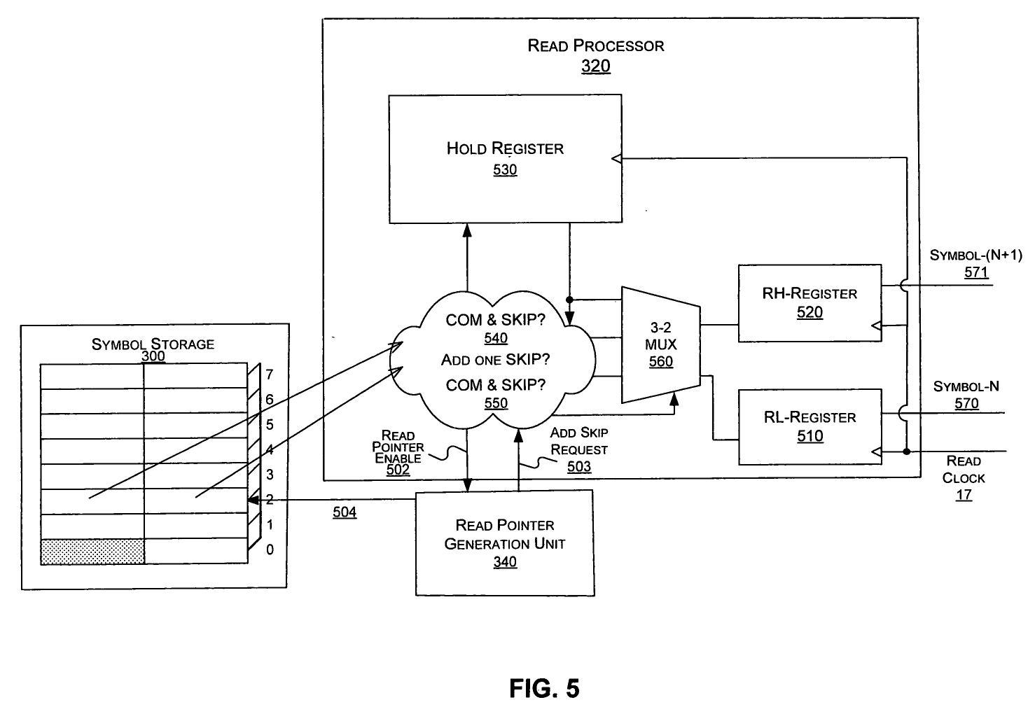

FIG. 5 illustrates an exemplary circuit diagram of read processor 320 in the read clock domain part of FIG. 3 according to some embodiments of the invention. Read processor may include, among other things, two output symbol registers 510 and 520, a hold register 530, two equality comparators 540 and 550, and a three-to-two mux selector 560.

According to the PCI-E Gen2 signaling rate configuration, a read cycle is defined as each read clock cycle. Read processor 320 reads two symbols out of symbol storage 300 clocked out in one read cycle. Read processor 320 also monitors the symbols out of symbol storage 300. When the request of adding a SKIP symbol has been asserted and a SKIP ordered-set is read out, read processor 320 has the ability to add one SKIP symbol to compensate for the frequency difference between the write clock and the read clock. This allows the write clock 13 to be slower than the read clock 17 without causing the undesirable data underflow.

Read processor 320 reads out the stored symbol data, according to read pointer position 504, from symbol storage 300 and maintains the symbol's data original order. Read processor 320 provides equality comparator 540 to determine whether the current symbols read out from symbol storage 300 are a SKIP ordered-set. If the SKIP-ordered set does not occur, the two symbols can be latched to RL-register 510 and RH-register 520 at the active edge of read clock 17. Further, read processor 320 activates read pointer enable signal 502 to increment the read pointer at symbol storage 300 after receiving the two stored symbol data. The read pointer enable signal 502 dictates whether the current read operation from the buffer is performed.

If equality comparator 540 determines that the SKIP-ordered set has occurred, read processor 320 can transmit read pointer enable signal 502 to read pointer generation unit 340 so that read pointer generation unit 340 can provide an add SKIP request signal 503 to read processor 320. Upon receiving the add SKIP request signal 503, read processor 320 can begin monitoring the incoming symbols out of the symbol storage 300. When the add SKIP request signal 503 has been asserted and a SKIP ordered-set is detected (the equality comparator 540 is true), read processor 320 can record the SKIP symbol (e.g., the value of second symbol out of the buffer is a SKIP character) at hold register 530. Read processor 320 performs the current read operation by providing symbol-rl and symbol-rh to receiver. Read pointer enable signal 502 can also be asserted to increment the read pointer associated with symbol storage 300. During the next read operation, the SKIP character in hold register 530 is assembled together with the first new symbol read out from symbol storage 300, and latched to rl-register 510 and rh-register 520, respectively, while the second new symbol read out from the buffer is provided to hold register 530. Then, read processor 320 performs the current read operation and increments the read pointer associated with symbol storage 300 to be ready for the next read operation. The special assembly process occurs until the next new SKIP symbol is added. When the number of added SKIP symbols runs up to an even number, the read pointer enable signal 502 is de-asserted for one read clock cycle to disable the read pointer increment and the current reading operation from symbol storage 300 is not performed. Beginning from this time, the read process resumes by latching the two symbols to rl-register 510 and rh-register 520 at the active edge of read clock 17. This process can occur until the number of SKIP symbols runs to an odd number.

Read processor 320 provides two equality comparators 540 and 550 because three symbols appear before they are delivered to output register for one read cycle. A three-to-two mux selector 560 selects two out of the three symbols based on the input received from equality comparators 540, 550.

In short, the read processor 320 can add one SKIP symbol to appropriately manage elastic buffer 18 and ensure that all symbols maintain their original orders. The PCI-E Gen2 signaling rate is matched by flexible control on read hold register.

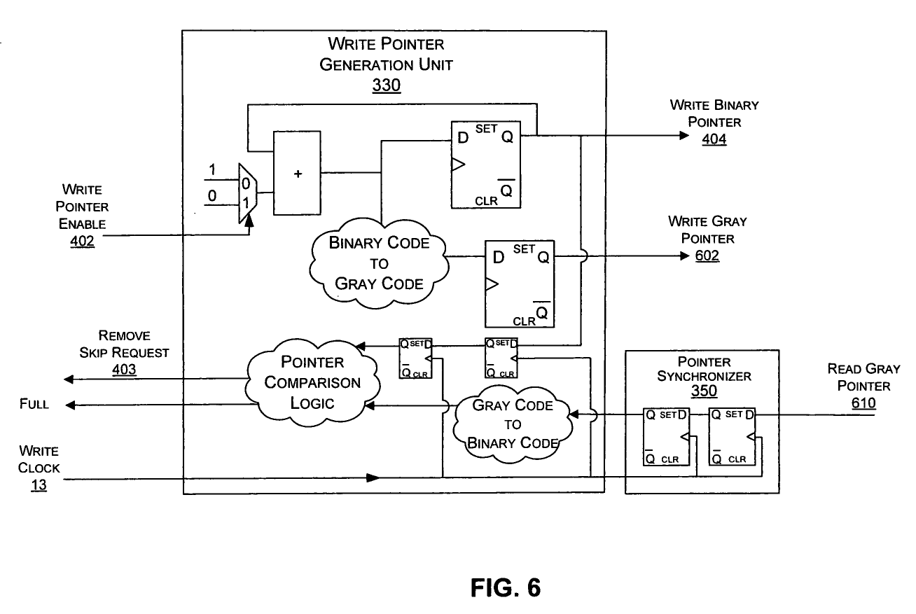

FIG. 6 illustrates an exemplary circuit diagram of write pointer generation unit 330. Write pointer generation unit 330, which operates at write clock 13, controls the write pointer location according to symbol storage 300, and generates a remove SKIP request signal 403 if the symbol storage is almost full.

There are two types of write pointers. Write binary pointer 404 addresses the location within symbol storage 300 and Gray code pointer 602 synchronizes the write pointer into the read clock domain. The pointer generation part of write pointer generation unit 330 may be an N-bit counter, where 2̂n represents the total number of memory locations in symbol storage 300. This counter may effectively increment when receiving an asserted write pointer enable signal 402 from write processor 310. Alternatively, the counter may not increment when receiving a de-asserted write enable signal 402 from write processor 310.

Elastic buffer's overflow or underflow can be a critical problem. In some embodiments, it may be necessary to ensure that data is read from the buffer in the same order that it was written to the buffer. Reading data that has not been written or writing data over data that has not yet been read may result in data packet corruption in elastic buffer 18.

Underflow or overflow status can be detected by monitoring the relationship between the two pointers by computing the number of symbols contained in elastic buffer 18. Elastic buffer 18 may be almost full when the number of symbols contained in the buffer comes close to the capacity of the buffer. In some embodiments, write pointer generation unit 330 can assert remove SKIP request signal 403 when the symbol number in elastic buffer 18 is more than a pre-defined value. The pre-defined value can be calculated from the required minimum latency of the elastic buffer when the link runs in a worst-case scenario. Similarly, elastic buffer 18 may be almost empty when the number of symbols contained in the buffer comes close to zero. In some embodiments, read pointer generation unit 340 can assert add SKIP request signal 503 when the symbol number in elastic buffer is less than a pre-defined value.

When symbol storage 300 is full, the write operation can be disabled and, accordingly, the write pointer is not incremented. The status indicator of elastic buffer 18 asserts to full state for a clock cycle and elastic buffer 18 can discard the two incoming symbols. Similarly, when symbol storage 300 is empty, the next read operation can be suspended and, accordingly, the read pointer is not incremented. The status indicator of elastic buffer 18 asserts to an empty state for a clock cycle and elastic buffer 18 can insert a pre-defined character (e.g., EDB, PCI-E) at the read cycle.

The pointer synchronization unit 350 performs clock domain synchronization in order for each interface to monitor the actions of the other. Because the write and read pointers are generated in two different clock domains, elastic buffer 18 uses Gray code for the two pointers to eliminate the problem associated with trying to synchronize multiple changing bit pointers for the two clock domains. Gray code is a unit of distance code where only one bit is changed between two adjacent codes. At worst, if a synchronizing clock signal comes during the middle of a gray code transition, the synchronized value may be the old value. This has no effect on the current implementation and maintains the integrity of the link data. In some embodiments, the Gray-coded pointer can be synchronized to the opposite clock domain by a simple two-stage flip-flop synchronizer. However, the process of a typical synchronized pointer may have two clocks' latency, and the comparison of two pointers is pessimistic and inaccurate. To overcome this, in some embodiments, the pointer synchronization unit delays the current clock pointer for two clock cycles and compensates the two pointers at approximately the same time as well.

While only a write pointer generation unit 330 is illustrated in this figure and its corresponding text, one of ordinary skill in the art will appreciate that read pointer generation unit 340 can be derived from FIG. 6 and its corresponding text. Read pointer generation unit 340, which operates at read clock 17, controls the read pointer location according to symbol storage 300, and generates add SKIP request signal 503 if the symbol storage is almost empty.

As described in the foregoing embodiment, the technique and method described in present invention provides an improved implementation of elastic buffer. According to some embodiments, elastic buffer 18 can be accomplished using integrated circuit techniques. Compared with the handshaking implementation mechanism, the elastic buffer has a smaller area and a lower latency because it does not need to have multi-stage data hold registers. Furthermore, even if the elastic buffer is in overflow or underflow state, there are still several safe clock cycles because of the minor frequency difference between the write and read ends of the elastic buffer. Therefore, the implementation method of elastic buffer also can provide a better timing slack for detail optimization.

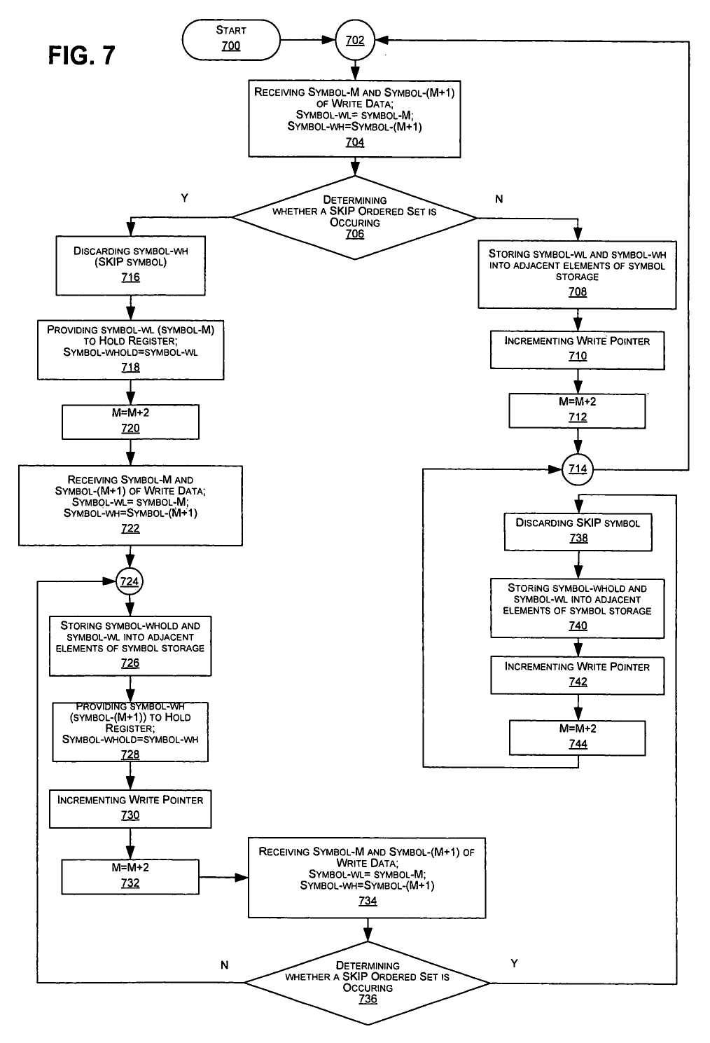

FIG. 7 represents an exemplary method for determining whether a SKIP ordered set has occurred at a write clock domain of an elastic buffer. It will be readily appreciated by one of ordinary skill in the art that the illustrated procedure can be altered to delete steps, move steps, or further include additional steps. After initial start step 700 and the method proceeding through connector 702, an elastic buffer receives an symbol-M and an symbol-(M+1) of write data at step 704. Symbol-M and symbol-(M+1) can represent an incoming write data, where M is a counter value. These symbols can be provided to a WL-register and a WH-register. WL-register can store symbol-M as symbol-wl (symbol-wl=symbol-M), while WH-register can store symbol-(M+1) as symbol-wh (symbol-wh=symbol-(M+1)).

After receiving step 704, the elastic buffer can determine whether a SKIP ordered set is occurring in step 706. The elastic buffer can determine this by examining and comparing symbol-wl and symbol-wh. For example, the stored symbols could be a COM and SKIP symbols, or two SKIP symbols. In some embodiments, elastic buffer may not implement the determining step 706 based on the overflow or underflow status of symbol storage. For example, as described above, a pointer synchronizer may monitor the status of the storage buffer to determine whether there is underflow or overflow. Based on this monitoring, the pointer synchronizer can implement determining step 706.

If a SKIP ordered set is not occurring, in step 708, the elastic buffer can store symbol-wl and symbol-wh into adjacent elements of symbol storage. Then, the elastic buffer can increment the write pointer two spots according to the two stored symbols in step 710 and can prepare itself to receive two new incoming M-type symbols by adding two to the counter value of M (M=M+2) in step 712. The method then proceeds through connectors 714 and 702 and can begin again at receiving step 704.

On the other hand, if a SKIP ordered set occurs according to determination step 706, the elastic buffer can discard the SKIP symbol located in symbol-wh in step 716. After discarding step 716, elastic buffer can provide symbol-wl (symbol-M) to a hold register, thereby designating symbol-whold=symbol-wl. The elastic buffer can then prepare itself to receive two new incoming M-type symbols by adding two to the value of M (M=M+2) in step 720. Then, the elastic buffer can receive another symbol-M and (M+1) symbol of write data in step 722. Once again, symbol-M corresponds to symbol-wl (symbol-wl=symbol-M) and symbol-(M+1) corresponds to symbol-wh (symbol-wh=symbol-(M+1)). After receiving step 722, the method proceeds through connector 724 to step 726. In step 726, the elastic buffer stores symbol-whold (assigned its value in step 718) and symbol-wl into adjacent elements of symbol storage. Because the symbol assigned to symbol-whold was received by elastic buffer prior to the symbol assigned to symbol-wl, elastic buffer can store symbol-whold in a prior symbol element of the symbol storage than symbol-wl. After storing step 726, elastic buffer can provide symbol-wh (symbol-(M+1)) to hold register in step 728, thereby assigning symbol-wh to symbol-whold (symbol-whold=symbol-wh). Then, the elastic buffer can increment the write pointer two spots according to the two stored symbols in step 726. Further, elastic buffer can prepare itself to receive two new incoming M-type symbols by adding two to the counter value of M (M=M+2) in step 732. In some embodiments, steps 730 and/or 732 can precede step 728.

Next, the elastic buffer can receive another symbol-M and (M+1) symbol of write data in step 734. Once again, symbol-M corresponds to symbol-wl (symbol-wl=symbol-M) and symbol-(M+1) corresponds to symbol-wh (symbol-wh=symbol-(M+1)). After receiving step 734, the elastic buffer can determine whether a SKIP ordered set is occurring in step 736. Once again, the elastic buffer can determine this by examining and comparing symbol-wl and symbol-wh. If not, the method proceeds to connector 724 where the method starting at storing step 726 is executed again.

On the other hand, if a SKIP ordered set occurs according to determination step 736, the elastic buffer can discard a SKIP symbol associated with one of symbol-wl or symbol-wh in step 738. In this particular embodiment, a SKIP symbol associated with symbol-wh will be discarded. Then, the elastic buffer stores symbol-whold and symbol-wl into adjacent elements of symbol storage in step 740. Because the symbol assigned to symbol-whold was received by elastic buffer prior to the symbol assigned to symbol-wl, elastic buffer can store symbol-whold in a prior symbol element of the symbol storage than symbol-wl. Then, the elastic buffer can increment the write pointer two spots according to the two stored symbols in step 742 and can prepare itself to receive two new incoming M-type symbols by adding two to the counter value of M (M=M+2) in step 744. The method then proceeds through connectors 714 and 702 and can begin again at receiving step 704.

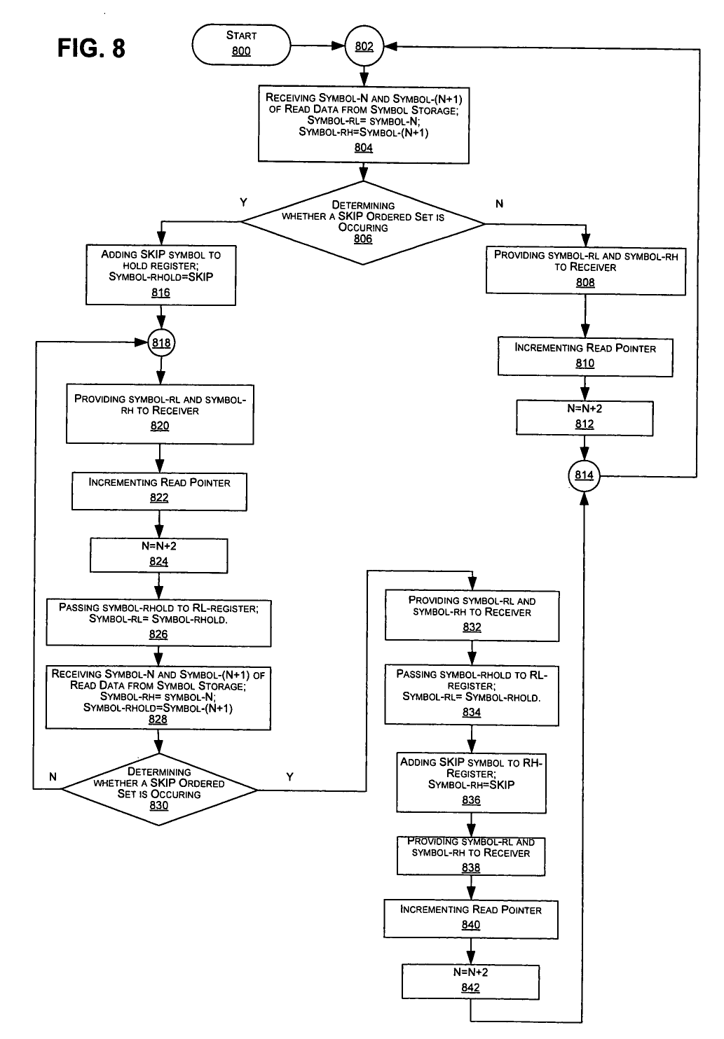

FIG. 8 represents an exemplary method for determining whether a SKIP ordered set has occurred at a read clock domain of an elastic buffer. It will be readily appreciated by one of ordinary skill in the art that the illustrated procedure can be altered to delete steps, move steps, or further include additional steps. After initial start step 800 and the method proceeding through connector 802, an elastic buffer receives symbol-N and symbol-(N+1) of write data at step 804. Symbol-N and symbol-(N+1) can represent an incoming read data provided by a symbol storage, where N is a counter value. These symbols can be provided to an RL-register and an RH-register. RL-register can store symbol-N as symbol-rl (symbol-rl=symbol-N), while RH-register can store symbol-(N+1) as symbol-rh (symbol-rh=symbol-(N+1)).

After receiving step 804, the elastic buffer can determine whether a SKIP ordered set is occurring in step 806. The elastic buffer can determine this by examining and comparing symbol-rl and symbol-rh. For example, the stored symbols could be a COM and SKIP symbols, or two SKIP symbols. In some embodiments, elastic buffer may not implement the determining step 806 based on the overflow or underflow status of symbol storage. For example, as described above, a pointer synchronizer may monitor the status of the storage buffer to determine whether there is underflow or overflow. Based on this monitoring, the pointer synchronizer can implement determining step 806.

If a SKIP ordered set is not occurring, in step 808, the elastic buffer can provide symbol-rl and symbol-rh to a receiver. Then, in step 810, the elastic buffer can increment the read pointer two spots to point to the next two symbol elements of symbol storage to be read into the read clock domain of the elastic buffer. Further, the elastic buffer can prepare itself to receive two new incoming N-type symbols by adding two to the counter value of N (N=N+2) in step 812. In some embodiments, steps 810 and 812 can occur at any point between their current location and after receiving step 804. The method then proceeds through connectors 814 and 802 and can begin again at receiving step 804.

On the other hand, if a SKIP ordered set occurs according to determination step 806, the elastic buffer adds a SKIP symbol to hold register in step 816, thereby assigning a SKIP symbol to symbol-rhold (symbol-rhold=SKIP). The method proceeds through connector 818 to providing step 820. In step 820, the elastic buffer can provide symbol-rl and symbol-rh to a receiver. Then, the elastic buffer can increment the read pointer two spots to point to the next two symbol elements storing symbols to be read into the read clock domain of the elastic buffer in step 822. Then, the elastic buffer can prepare itself to receive two new incoming N-type symbols by adding two to the counter value of N (N=N+2) in step 824. In some embodiments, steps 822 and 824 can occur at any point between their current location and after receiving step 804.

After step 824, the elastic buffer passes symbol-rhold to RL-register in step 826, thereby assigning the value of symbol-rhold to symbol-rl (symbol-rl=symbol-rhold). Next, the elastic buffer receives an symbol-N and a symbol-(N+1) of write data at step 828. The N-symbol value is provided to RH-register (symbol-rh=symbol-N), while the symbol-(N+1) value is provided to the hold register (symbol-rhold=symbol-(N+1)).

After receiving step 828, the elastic buffer can determine whether a SKIP ordered set is occurring in step 830. The elastic buffer can determine this by examining and comparing symbol-rl and symbol-rh. If not, the method proceeds through connector 818 to providing step 820.

On the other hand, if the elastic buffer determines that a SKIP ordered set is occurring in step 830, the elastic buffer can provide symbol-rl and symbol-rh to a receiver in step 832. Then, the elastic buffer passes symbol-rhold to RL-register in step 834, thereby assigning the value of symbol-rhold to symbol-rl (symbol-rl=symbol-rhold). After step 834, the elastic buffer can add a SKIP symbol to an RH-register in step 836, thereby assigning the SKIP symbol to symbol-rh (symbol-rh=SKIP). Subsequently, in step 838, the elastic buffer provides the values of symbol-rl and symbol-rh to receiver.

After step 838, the elastic buffer can increment the read pointer two spots to point to the next two symbol elements storing symbols to be read into the read clock domain of the elastic buffer in step 840. Then, the elastic buffer can prepare itself to receive two new incoming N-type symbols by adding two to the counter value of N (N=N+2) in step 842. In some embodiments, steps 840 and 842 can occur at any point between their current location and after receiving step 828. After step 842, the method proceeds through connectors 814 and 802 to receiving step 804.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

In the preceding specification, the invention has been described with reference to specific exemplary embodiments. It will however, be evident that various modifications and changes may be made without departing from the broader spirit and scope of the invention as set forth in the claims that follow. The specification and drawings are accordingly to be regarded as illustrative rather than restrictive sense. Other embodiments of the invention may be apparent to those skilled in the art from consideration of the specification and practice of the invention disclosed herein.

What is claimed is:

1. An elastic buffer for synchronizing an asynchronous data transmission between a transmitter and a receiver by compensating a clock difference between a write clock from the transmitter and the read clock from a receiver, the elastic buffer comprising:
a write processor that receives write data, which represents at least a first write symbol and a second write symbol, from the transmitter based on a write clock signal, wherein the write processor further includes:
a first write register that stores the first write symbol;
a second write register that stores the second write symbol;
a write comparator that determines whether the first write symbol and the second write symbol correspond to a SKIP ordered set, which may include at least one of first write symbol and second write symbol being a SKIP symbol; and
a write hold register that has the capability to store a symbol of write data based on the determination by the write comparator, wherein, according to the determination, the write processor discards the SKIP symbol of one of first write symbol or second write symbol, provides the non-discarded symbol of first write symbol or second write symbol to the write hold register, receives a subsequent set of write data including at least a third write symbol;
a symbol storage configured to store the non-discarded symbol located in write hold register and the third write symbol according to the write clock; and
a read processor that receives read data, which represents at least a first read symbol and a second read symbol, from the symbol storage based on a read clock signal from the receiver, wherein the read processor further includes:
a first read register that stores the first read symbol;
a second read register that stores the second read symbol;
a read comparator that determines whether the first read symbol and the second read symbol correspond to a SKIP ordered set, which may include at least one of first read symbol and second read symbol being a SKIP symbol; and
a read hold register that has the capability to store a symbol of read data based on the determination by the read comparator, wherein, according to the determination, the read processor adds a SKIP symbol to the read hold register, provides the first read symbol and the second read symbol to the receiver, passes the SKIP symbol from read hold register to the first read register, receives a subsequent set of read data including at least a third read symbol, and provides the SKIP symbol from first read register and the third read symbol to the receiver.

2. An elastic buffer comprising:
a symbol storage coupled to receive transition data from a transmitter and to store the transition data in a plurality of addressable symbol storage elements;
a write clock domain, which operates at a recovery clock, for selecting a symbol storage element of symbol storage to store the transition data, determining whether a SKIP ordered set has occurred, and deleting a SKIP symbol of the SKIP ordered set based on the determination to prevent the deleted SKIP symbol from being stored in symbol storage; and
a read clock domain, which operates at a local clock, for selecting a symbol storage element of the symbol storage to retrieve the transition data as receiver data, determining whether a SKIP ordered set is occurring, adding a SKIP symbol to the receiver data based on the determination; and providing the receiver data to a receiver.

3. The elastic buffer of claim 2, wherein the write clock domain further comprises:
a write processor configured to receive the transition data and provide the transition data to symbol storage; and
a write pointer generation unit configured to update a write pointer position based on the write processor storing the transition data in symbol storage.

4. The elastic buffer of claim 3, wherein the write processor is configured to receive at least two symbols of transition data per write clock cycle, the write processor further comprising:
a first write register that stores a first write symbol of transition data;
a second write register that stores a second write symbol of transition data;
a write comparator that determines whether the first write symbol and the second write symbol correspond to a SKIP ordered set, which may include at least one of first write symbol and second write symbol being a SKIP symbol; and
a write hold register that has the capability to store a symbol of write data based on the determination by the write comparator, wherein, according to the determination, the write processor discards the SKIP symbol of one of first write symbol or second write symbol, provides the non-discarded symbol of first write symbol or second write symbol to the write hold register, receives a subsequent set of transition data including at least a third write symbol, and stores the non-discarded symbol and the third write symbol into the symbol storage.

5. The elastic buffer of claim 2, wherein the read clock domain further comprises:
a read processor configured to receive receiver data from the symbol storage and provide the receiver data to a receiver; and
a read pointer generation unit configured to update a read pointer position based on the read processor receiving the receiver data from symbol storage.

6. The elastic buffer of claim 5, wherein the read processor is configured to receive at least symbols of receiver data per read clock cycle, the read processor further comprising:
a first read register that stores a first read symbol of receiver data;
a second read register that stores a second read symbol of receiver data;
a read comparator that determines whether the first read symbol and the second read symbol correspond to a SKIP ordered set, which may include at least one of first read symbol and second read symbol being a SKIP symbol; and
a read hold register that has the capability to store a symbol of receiver data based on the determination by the read comparator, wherein, according to the determination, the read processor adds a SKIP symbol to the read hold register, provides the first read symbol and the second read symbol to the receiver, passes the SKIP symbol from read hold register to the first read register, receives a subsequent set of receiver data including at least a third read symbol, and provides the SKIP symbol and the third read symbol to the receiver.

7. The elastic buffer of claim 2, further comprising a pointer synchronizer that receives, from the write clock domain, a write pointer data associated with the symbol storage, that receives, from the read clock domain, a read pointer data associated with the symbol storage, that monitors the relationship between the write pointer and the read pointer to determine whether a predetermined threshold has been met; and that notifies at least one of the write clock domain and the read clock domain to adjust its corresponding SKIP ordered determination based on monitored determination.

8. A system comprising:
a clock data recovery that receives an incoming bit stream and provides a recovery clock;
a converter that receives the incoming bit stream and provides transition data;
a receiver for receiving receiver data, wherein the receiver operates on a local clock;
an elastic buffer comprising:
a symbol storage coupled to receive transition data from the converter according to the recovery clock and to store the transition data in a plurality of addressable symbol storage elements;
a write clock domain, which operates at the recovery clock, for selecting a symbol storage element of symbol storage to store the transition data, determining whether a SKIP ordered set has occurred, and deleting a SKIP symbol of the SKIP ordered set based on the determination to prevent the deleted SKIP symbol from being stored in symbol storage; and
a read clock domain, which operates at the local clock, for selecting a symbol storage element of the symbol storage to retrieve the transition data as receiver data, determining whether a SKIP ordered set is occurring, adding a SKIP symbol to the receiver data based on the determination; and providing the receiver data to the receiver.

9. The system of claim 8, wherein the write clock domain further comprises:
a write processor configured to receive the transition data and provide the transition data to symbol storage; and
a write pointer generation unit configured to update a write pointer position based on the write processor storing the transition data.

10. The system of claim 9, wherein the write processor is configured to receive at least two symbols of transition data per write clock cycle, the write processor further comprising:
a first write register that stores a first write symbol of transition data;
a second write register that stores a second write symbol of transition data;
a write comparator that determines whether the first write symbol and the second write symbol correspond to a SKIP ordered set, which may include at least one of first write symbol and second write symbol being a SKIP symbol; and
a write hold register that has the capability to store a symbol of write data based on the determination by the write comparator, wherein, according to the determination, the write processor discards the SKIP symbol of one of first write symbol or second write symbol, provides the non-discarded symbol of first write symbol or second write symbol to the write hold register, receives a subsequent set of transition data including at least a third write symbol, and stores the non-discarded symbol and the third write symbol into the symbol storage.

11. The system of claim 8, wherein the read clock domain further comprises:
a read processor configured to receive receiver data from the symbol storage and provide the receiver data to a receiver; and
a read pointer generation unit configured to update a read pointer position based on the read processor receiving the receiver data.

12. The system of claim 11, wherein the read processor is configured to receive at least symbols of receiver data per read clock cycle, the read processor further comprising:
a first read register that stores a first read symbol of receiver data;
a second read register that stores a second read symbol of receiver data;
a read comparator that determines whether the first read symbol and the second read symbol correspond to a SKIP ordered set, which may include at least one of first read symbol and second read symbol being a SKIP symbol; and
a read hold register that has the capability to store a symbol of receiver data based on the determination by the read comparator, wherein, according to the determination, the read processor adds a SKIP symbol to the read hold register, provides the first read symbol and the second read symbol to the receiver, passes the SKIP symbol from read hold register to the first read register, receives a subsequent set of receiver data including at least a third read symbol, and provides the SKIP symbol and the third read symbol to the receiver.

13. The system of claim 8, further comprising a pointer synchronizer that receives, from the write clock domain, a write pointer data associated with the symbol storage, that receives, from the read clock domain, a read pointer data associated with the symbol storage, that monitors the relationship between the write pointer and the read pointer to determine whether a predetermined threshold has been met; and that notifies at least one of the write clock domain and the read clock domain to adjust its corresponding SKIP ordered determination based on monitored determination.

14. A method comprising:
receiving a first set of write data, which includes a first symbol and a second symbol, according to a write clock;
determining whether the received write data includes a first SKIP ordered set;
discarding one of the first symbol or second symbol based on the determination wherein at least one first symbol and second symbol is a SKIP symbol;
receiving a second set of write data, which includes at least a third symbol; and
storing the non-discarded symbol and the third symbol in a symbol storage, which can provide the non-discarded symbol and the third symbol to a read clock portion of an elastic buffer for providing to a receiver according to a receiver clock cycle.

15. The method of claim 14, wherein the determining is based on receiving overflow data indicating that the number of filled symbol elements of the symbol storage has at least met a predetermined threshold.

16. The method of claim 14, wherein receiving the first set of write data further comprises:
storing the first symbol in a first register; and
storing the second symbol in a second register, wherein the non-discarded symbol of the first symbol or second symbol is provided to a third register, while the first register receives a third symbol of a second set of write data and the second register receives a fourth symbol of a second set of write data.

17. The method of claim 14, further comprising:
determining whether a received subsequent set of write data includes a second SKIP ordered set, wherein the received subsequent set of write data includes at least two symbols;
discarding a SKIP symbol of the subsequent set of write data based on the determination; and
storing the non-discarded symbol of the subsequent set of write data and a symbol from a received previous set of write data into the symbol storage.

18. A method comprising:
receiving a first set of read data from a symbol storage based on a clock cycle from a receiver, wherein the first set of read data includes a first symbol and a second symbol;
determining whether the received read data includes a first SKIP ordered set;
adding a SKIP symbol based on the determination;
transmitting the first set of read data to the receiver;
receiving a second set of read data from the symbol storage, wherein the second set of read data includes a third symbol and a fourth symbol; and
transmitting the SKIP symbol and the third symbol to the receiver.

19. The method of claim 18, wherein the determining is based on receiving overflow data indicating that the number of filled symbol elements of the symbol storage has at least met a predetermined threshold.

20. The method of claim 18, wherein receiving the second set of read data further comprises:
storing the third symbol in a first register; and
storing the fourth symbol in a second register, wherein the added SKIP symbol is stored in a third register.

21. The method of claim 18, further comprising:
determining whether a received subsequent set of read data includes a second SKIP ordered set, wherein the received subsequent set of read data includes at least two symbols;
adding a SKIP symbol based on the determination; and
transmitting the SKIP symbol and a symbol of the received subsequent set of read data to the receiver.
